(19) United States
(12) Patent Application Publication
(10) Pub. No.: US 2005/0116086 A1
(43) Pub. Date: Jun. 2, 2005

(54) Wing assemblies for aircraft

(76) Inventor: Paul Orazi, N Miami, FL (US)

Correspondence Address: PAUL ORAZI, BOX 610192, N MIAMI, FL, 33261, US

(21) Appl. No.: 10/705,529

(22) Filed: Nov. 12, 2003

(51) Int. Cl. B64C 27/22

(52) U.S. Cl. 244/7 A

(57) ABSTRACT

A rotary wing having a spar that flexes and crosses the axis of t the spar in two or more points. The spar mounts a flying surface extending spanwise and rotatable about the longitudinal axis of the spar without the transmission of flexural movement to the wing sheets. The spar mounts a rib extending chordwise and rotatable about the spar and comprising rib means extending spanwise and positioned such that they can engage a portion of the wing sheets and transmit rotation to the wing sheets without interfering with the relative movement between the wing sheets and the spar. The chordwise rib is adapted to receive power transmission such t that while rotating is capable to transmit rotation to the wing sheets through the spanwise extending ribsmeans. The transmission of rotation to the wing sheets is achieved without transmission of rotation to the spar.

### BACKGROUND OF THE INVENTION

A variant of my U.S. Pat. No. 4,577,815 or 5,984,230 shows a rotary wing having a spar that flexes and crosses the axis of the spar in two or more points, without transmission of flexural movement to the wing sheets.

The spar mounts one or more flying surfaces extending spanwise and rotatable about said spar about the longitudinal axis of said spar.

### SUMMARY OF THE INVENTION

The present invention relates to a wing assembly in which axial rotation from engine power can be transmitted to the wing sheets of the above mentioned type. In this assembly the engine transmits power to the surface of the wing sheets without transmitting it to the framework, through a structure independent from the wing framework, without interfering with the relative movement between the wing sheets and the frame.

### BRIEF DESCRIPTION OF THE INVENTION

The invention is illustrated, by way of example, in the accompanying drawings in which:

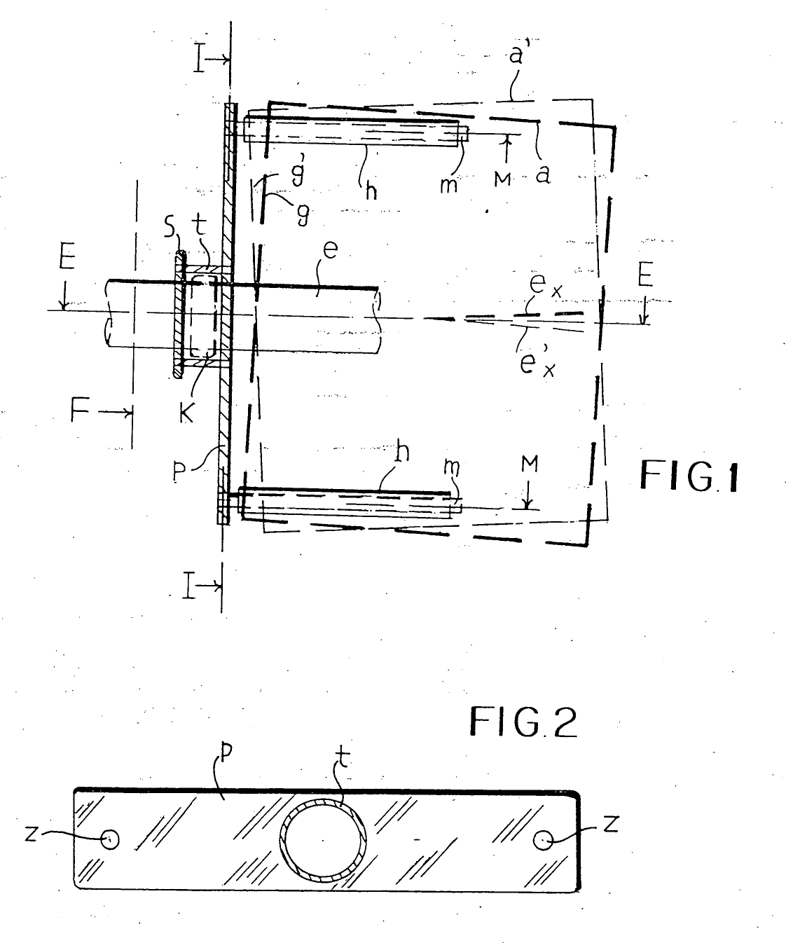

FIG. 1 is a side elevation of an embodiment of a wing with a power transmission assembly, shown in rotary motion about its spar.

FIG. 2 is a detail of FIG. 1

FIG. 3 is a sectional elevation of the assembly along the line I-I of FIG. 1

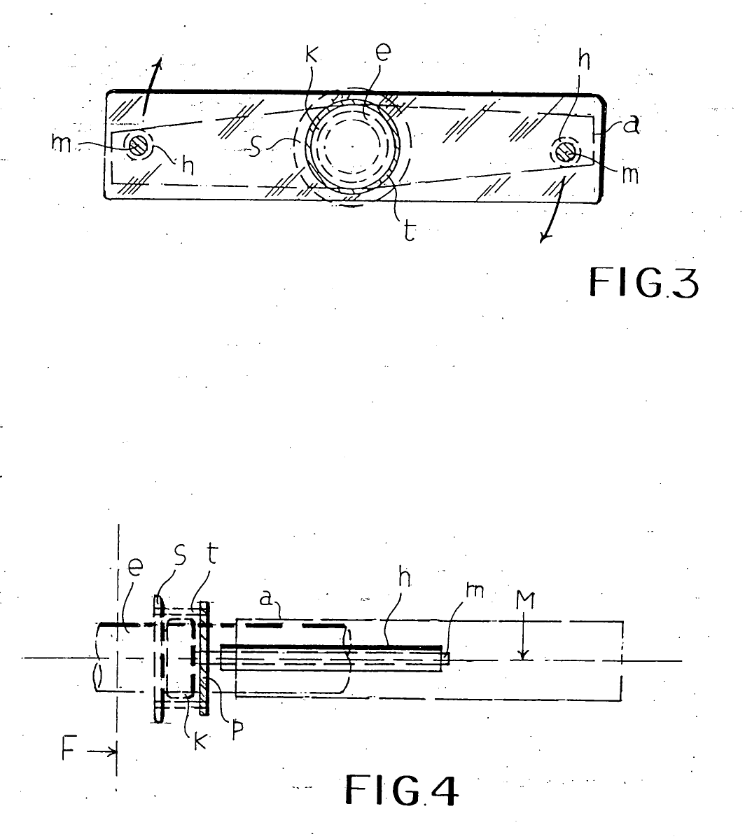

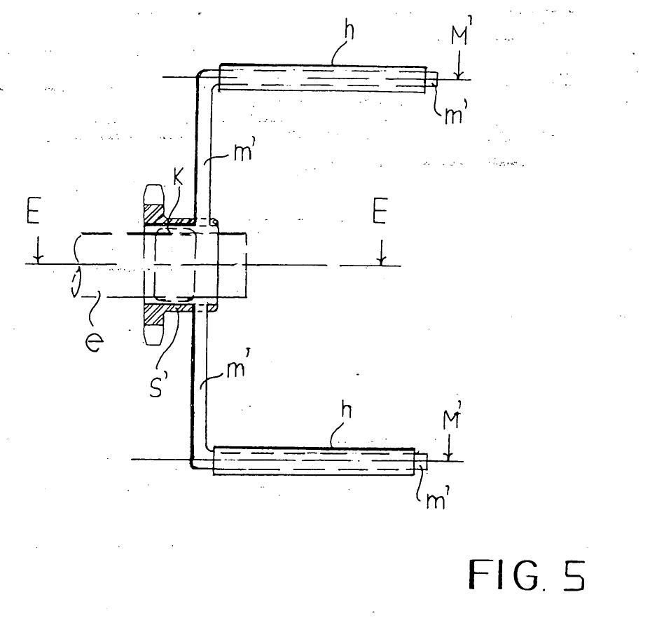

FIG. 4 is a sectional elevation of the assembly along the line M of FIG. 1

FIG. 5 is a plan view of the assembly shown in a modified construction.

### DETAILED DESCRIPTION OF THE INVENTION

Referring to the drawings an aircraft fuselage (not shown) has an edge along the line F of FIG. 1 and carries a tubular spar e transversely mounted in it (as in my previous Patents), and extending outside the said fuselage edge F and forming part of the wing framework (constituted by the spare and a plurality of bearings,) and the wing sheets forming flying surfaces are able to slide on said frame.

The wing can comprise one single wing panel (as in U.S. Pat. No. 4,577,815) or two wing panels (as in U.S. Pat. No. 5,984,230). In FIG. 1 there is shown the panel a, namely the first wing panel close to the fuselage edge F, irrespective if it is the said single panel or the first of the two said panels.

The flying surface construction is shown in my U.S. Pat. No. 4,577,815 and each flying surface is made in the form of longitudinally extending wing sheets linked at their edges to form a box-like structure (not shown).

The assembly for driving the wing sheet a comprises a transverse rib p made of a plate of sheet of heavy gauge extending symmetrically to both sides of the spar, as can be seen in FIG. 1. The said plate p has a hole in its center to accomodate a tube section t, as in FIGS. 1, 2, 3.

The said hole being of a diameter corresponding to the outer diameter of the said tube section t which is welded all around its outer circumference to the said plate p as shown in FIG. 2. The tube t has its inner diameter of a size to house the outer ring of the bearing k as in FIGS. 1, 3, 4. (Retaining rings not shown) within the tube t keep the bearing k in place).

The said bearing K being in turn of a bore corresponding to the outer diameter of the spar e as in FIGS. 1, 3, 4, such that the said bearing is able to roll on the said spar e.

A power transmission means made of a sprocket S as can be seen in FIGS. 1, 3, 4 (the sprocket being of the flat type) and bored corresponding to the outer diameter of the said tube t is welded to the said tube t (in the same manner as the said plate p) all around the tube circumference. S in FIGS. 1, 3, 4 can be a sprocket or a timing pulley or a gear. The sprocket S (Or the timing pulley or the gear) being mounted maintaining a spanwise clearance between it and the plate p such that the sprocket S can mount a chain (or S mounting a timing belt to be driven and function as a power transmission means. The sprocket S and the plate p can thus rotate about the spar e through the bearing k. A retaining ring (not shown) is mounted on the spar flanking the sprocket S to prevent the span-wise movement of the assembly.

A shaft rotatably mounted in the fuselage (not shown) and parallel to the spar axis E-E and extending out of the said fuselage, and rotated by an engine included in the fuselage (not shown), can mount a corresponding driver sprocket, or a driver timing pulley or a driver gear (not shown) and thus transmit rotation to the aforementioned sprocket or timing pulley S through a chain or a timing belt and thus drive the transverse rib p to rotate about the spar e.

In case of S being a gear, the said shaft (not shown) is mounted closer to the spar e such that the driver gear mounted on the shaft can engage the gear S. The said plate (transverse rib) p, as in FIGS. 1, 3, 4 at its opposite ends mounts two longitudinally opposite spanwise ribs m made of tube or rod generally parallel to the spar axis E-E, their lenght being such to cover a portion of the wing sheets a.

At one of their tips the said spanwise ribs m are threaded (not shown) to be screwed in correspondent holes z of the plate p, as in FIG. 2 (and secured with nuts (not shown) also threaded. The said ribs m are thus symmetrically fixed to the plate p and are able to rotate about the spar e while the said plate p is rotating.

The said spanwise ribs m mount coaxially each one tube (sleeve) h of an inside diameter corresponding to their outer diameter, and of a lenght corresponding to their lenght, such that the said tubes h can turn about the said ribs m about the common axis M as in FIGS. 1, 4. Cotter pins (not shown) at the tips of the ribs m keep the tubes h in place.

As the tubes h extend longitudinally within a portion of the wing sheets, namely within a portion of the root wing panel a as in FIGS. 1, 4, and are detached from the said wing sheets, they can undergo a limited rolling on the wing sheets a in the plane of the wing, (as caused by the relative movement between the wing sheets and the frame, without interfering with the said relative movement), while driving the wing sheets, as they rotate with the ribs m about the spar. As illustrated in my previous Patents, while the spar e flexes and crosses its axis E-E as in FIG. 1, it reverses its curvature from eₓ to e′ₓ relatively to the surface of the wing sheets, and the longitudinal and chordal edges a and g (the same letter for the wing panel a is used for the longitudinal edge for clarity) travel from positions a and g to positions a′ and g′ in the chordal plane—For clarity, the relative movement perpendicularly to the plane of the wing, between the spanwise ribs or the tubes h and the wing sheets is not shown in FIG. 4 (the spar curvatures of flexion eₓ and e′ₓ are the same as shown in FIG. 1.

As can be seen in FIG. 3, the tubes (sleeves) h are of an outer diameter inferior to the distance between the opposite wing sheets (perpendicularly to the plane of the wing), such that they engage only one of the said opposite sheets a, and thus the said wing sheets can slide relatively to the said tubes h.

In case of a rotation direction opposite to that shown in FIG. 3, the tubes h engage only the sheet surfaces opposite to those shown in FIG. 3.

FIG. 5 shows a modified assembly in which a side hub type sprocket S′ is bored corresponding to the outer diameter of the bearing k to house the said bearing, and ribs (made of rods or tubes) m′ are bent at a square angle with their ends mounted in opposite holes bored in the said sprocket and welded to it, as can be seen in FIG. 5. In the same fashion as in FIGS. 1, 4, the ribs m′ mount the same coaxial tubes h capable of turning about them, about the common axis M′ and thus function as in the assembly of FIGS. 1, 4, relatively to the wing sheets. The chordal distance between the rib means m and also their lenght to cover the wing sheets portion should be suitable for engaging the wing sheets and drive them for axial rotation, as can be seen in FIG. 1.

The distance between the said opposite rib means m is to be inferior to the wing sheets chordal dimension such that during the wing sheets axial rotation, the said rib means keep clear from the wing sheets longitudinal edges as shown in FIG. 1, while the spar e has reached its maximum flexion, to permit the relative movement between the wing sheets and the frame. Also, as can be seen in FIG. 1, the transverse rib p is mounted such that a clearance is left between the said transverse rib p and the flying surface root edge g in order that said edge g can angle freely relatively to the said transverse rib p, to accomodate the relative movement between the wing sheets and the frame.

In the proximity of the fuselage edge F, as in FIG. 1, the spar e can be considered not deviating from its axis E-E. So this axis can be considered the axis of the said drive means S and of the said transverse rib p, which has fixed to it the spanwise ribs m.

So the spanwise ribs of FIG. 1 during rotation keep their axis M generally parallel to the spar axis E-E, and generally fixed relatively to the said axis, and thus they are independent from the spar flex. Thus the wing sheets during their aforementioned travel, undergo a limited movement relatively to the said generally fixed spanwise ribs in the chordal plane.

And, as the spar is stationary, and the spanwise ribs driving the wing sheets being not fixed to the spar and not rotated by the spar, do not constitute part of the frame (and do not bring any contribution to the wing sheets structural strenght) the transmission of rotation to the wing sheets is performed through a relative movement between ribs not fixed to the spar and the wing sheets, (though this relative movement is dependent by the relative movement between the wing sheets and the frame.)

1. A rotary wing assembly for an aircraft, said assembly comprising a spar intended to be mounted upon an aircraft fuselage, the spar mounting wing sheets forming flying surfaces, whereby during rotation of the wing sheets the said spar can flex without transmission of flexural movement to the wing sheets, the said spar mounting a rotatable transverse rib and a power transmission means coaxially fixed together for axial rotation about said spar, the said transverse rib comprising generally spanwise rib means oppositely fixed to it and extending within a portion of the wing sheets and detached from said wing sheets.

2. A rotary wing assembly for an aircraft, said assembly comprising a spar intended to be mounted upon an aircraft fuselage, the said spar mounting wing sheets-forming flying surfaces rotatable about its span axis, whereby during rotation of the wing sheets the said spar can flex without transmission of flexural movement to the wing sheets, the said spar mounting a transverse rib and a drive means adapted to be fixed together for axial rotation about the spar, the transverse rib comprising generally spanwise rib means extending within a portion of the said wing sheets, the wing sheets sliding on said spanwise rib means, the said rib means engaging the wing sheets such that axia rotation of said drive means is transmitted to said wing sheets.

3. An assembly according to claim 2, the power driving the said spanwise ribs being not applied to them from within the wing sheets.

4. A rotary wing assembly for an aircraft, said assembly comprising a spar intended to be mounted upon an aircraft fuselage, and wing sheets forming flying surfaces and mounted upon a frame including said spar, whereby during rotation of the wing sheets the said spar can flex without transmission of flexural movement to the wing sheets, the spar mounting a rotatable transverse rib adapted to receive power transmission through a drive means fixed to said transverse rib for axial rotation about said spar, the said transverse rib carrying opposed rib means extending generally spanwise within a portion of the said wing sheets, the wing sheets sliding upon the said rib means, the said rib means engaging the wing sheets such that axial rotation of said drive means is transmitted to said wing sheets, the said transverse rib and the said rib means constituting a structure independent from the frame, the wing sheets being driven by a structure bringing no contribution to the wing sheets structural strenght.

5. A rotary wing assembly for an aircraft, said assembly comprising a spar intended to be mounted upon an aircraft fuselage, the spar flexing and crossing its axis and mounting wing sheets forming flying surfaces rotatable about its longitudinal axis without transmission of flexural movement to the wing sheets, and rib means adapted to be fixed to a drive means rotatable about the spar,
the said rib means extending generally chordwise from opposite sides of the spar and forming an angle in the plane of the wing to extend generally spanwise to engage a portion of the wing sheets such that axial rotation of the said drive means can transmit rotation to the wing sheets through a relative movement between the said rib means and the said wing sheets, wherein the wing sheets undergo limited movement in the plane of the wing relatively to said rib means while the said rib means are relatively fixed in the said plane.

6. A rotary wing assembly for an aircraft, said assembly comprising a spar intended to be mounted upon an aircraft fuselage, and wing sheets forming flying surfaces and mounted upon a frame including said spar, whereby during rotation of the wing sheets the said spar can flex without transmission of flexural movement to the wing sheets, the spar mounting a rotatable coaxial drive means adapted to include rib means oppositely fixed to it and extending generally chordwise and forming an angle in the plane of the wing to extend generally spanwise within a portion of the said wing sheets, whereby the wing sheets can slide relatively to said rib means, the said rib means engaging the wing sheets such that axial rotation of said drive means is transmitted to said wing sheets, whereby the frame does not transmit rotation to said rib means.

7. A rotary wing assembly for an aircraft, said assembly comprising a spar intended to be mounted upon an aircraft fuselage, and wing sheets forming flying surfaces and mounted upon a frame including said spar, the spar flexing and crossing its axis and mounting said flying surfaces rotatable about its longitudinal axis without transmission of flexural movement to the wing sheets, the said fuselage comprising an engine, the spar mounting a rotatable transverse rib adapted to receive engine power from the said engine through a power transmission means coaxially fixed to the said transverse rib, the said transverse rib comprising generally spanwise rib means oppositely fixed to it and extending within a portion of the wing sheets and detached from said wing sheets and positioned such that rotation of said transverse rib is capable to drive the wing sheets, the said engine being capable to transmit power to the surface of the wing sheets without transmitting it to the frame.

8. An assembly according to claim 2, the said rib means being fixed to the said transverse rib in position suitable for engaging the wing sheets while allowing the relative movement between the wing sheets and the frame.

9. An assembly according to claim 1, the said flying surfaces including longitudinal edges, the said spanwise ribs being mounted at a chordal distance between them such that they keep clear from the said longitudinal edges and the wing sheets are able to angle in the chordal plane while the spar has reached its maximum flexion.

10. An assembly according to claim 4, the said flying surfaces including a root chordal edge, wherein a chordal clearance in the plane of the wing between the said transverse rib and the said chordal edge is maintained such to accomodate the angling of the said chordal edge during the 360° of angular rotation of the said flying surfaces.

11. An assembly according to claim 4, wherein the said rib means driving the wing sheets are positioned not in a chorwise direction.

12. An assembly according to claim 2, the said spanwise ribs mounting coaxial tubes capable to turn about them, wherein the said tubes engage the wing sheets such to transmit rotation to the said wing sheets while being able of rolling on the said wing sheets during the limited movement between the said spanwise ribs and the said wing sheets.

13. An assembly according to claim 2, the said spanwise ribs transmitting rotation to the wing sheets being not fixed to the spar and not rotated by the spar.

14. An assembly according to claim 7, the said spanwise ribs being independent from the spar flex.

15. An assembly according to claim 6, the axial rotation to the wing sheets being not transmitted through a relative movement between the wing sheets and frame means, wherein the said rotation is transmitted through a relative movement between the wing sheets and rib means not constituting part of the frame.

16. An assembly according to claim 5, wherein the spar has no drive means fixed to it.

17. An assembly according to claim 7, the chordal distance between said rib means being suitable for engaging the wing sheets and drive them for axial rotation while not hindering the relative movement between the wing sheets and the frame.

18. An assembly according to claim 7, the rotation being not transmitted to the wing sheets by the wing sheets of an adjacent flying surface with an autonomous assembly to achieve the flexing of the spar.

19. An assembly according to claim 7, the power being transmitted only to the root portion of the wing flanking the fuselage.

20. An assembly according to claim 2, the said transverse rib and the said drive means being mounted at the opposite ends of a tube section coaxial with the said spar such that a chordwise clearance between them is maintained.
